(19) United States
(12) Patent Application Publication
(10) Pub. No.: US 2007/0044154 A1
(43) Pub. Date: Feb. 22, 2007

(54) Mail reception system

(75) Inventor: Shohei Tsujimoto, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/505,843

(22) Filed: Aug. 18, 2006

(30) Foreign Application Priority Data
Aug. 19, 2005 (JP) 2005-239109

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

There is provided a mail reception system in which a mail relay device is communicatably connected to a virus check device. In the system, the mail relay device comprises a data reception unit to receive data from the external device, a data transmission unit to transmit the data received by the data reception unit to the virus check device before the data is transferred to the predetermined reception device, and a check result reception unit to receive information concerning a result of virus detection from the virus check device. The virus check device comprises a reception unit to receive the data from the data transmission unit, a virus detection unit to detect whether a virus is contained in the data, and a notification unit to transmit the information concerning a result of virus detection to the mail relay device.

### CROSS-REFERENCE TO RELATED APPLICATION

This application claims priority under 35 U.S.C. §119 from Japanese Patent Application No. 2005-239109, filed on Aug. 19, 2005. The entire subject matters of the application are incorporated herein by reference.

### BACKGROUND

1. Technical Field

Aspects of the present invention relate to a mail reception system capable of receiving data, such as facsimile document data, e-mail or image data, from an external device and transferring the data to a predetermined destination.

2. Related Art

With the development of the Internet, a large number of end user's devices are now connected to the Internet, for example, to access web sites or to send and receive e-mails. On the other hand, suffering caused by computer viruses (hereafter, simply referred to as viruses) is also increasing. The virus is a program designed to damage another program, files, a database, etc. The virus has at least one of an infection function, an incubation function and an attack function. The virus infects a computer through various types of media and data, such as optical discs which are exchanged between users or attached to a journal, programs or files downloaded from the Internet, or e-mail messages. If a user continues to use a user's device infected with a virus, the user's device may transmit the virus to another device. For this reason, computers are provided with a function of protecting themselves from viruses.

Peripheral devices, such as a printer or a scanner, are also required to have a virus detection function. In Japanese Patent Provisional Publication No. HEI 11-119927A (hereafter, referred to as JP HEI 11-119927A), a printer having a virus detection function is disclosed. The printer disclosed in JP HEI 11-119927A executes a virus detection process on a JAVA™ applet downloaded from an external device.

Recently, network peripheral devices having a function of network communication are widely used. As one of various types of network peripheral devices, a multifunction device having multiple functions, such as a telephone function, a facsimile function, a copy function, a printing function, a scanner function and a mailing function has been proposed. The multifunction device is connected to the Internet so as to achieve a function of receiving data from a device and transferring the data to another device through the Internet in accordance with a user's instruction. It is understood that if the network peripheral device (e.g., the multifunction device) is infected with a virus, the network peripheral device may infect a computer to which the network peripheral device is connected, and thereby cause expansion of the virus.

By implementing the virus detection function on the network peripheral device, the expansion of viruses from the network peripheral device can be prevented. However, the virus detection function requires the network peripheral device to store virus check data describing virus types with which target data (e.g, an e-mail) is to be checked. In order to support various types of viruses existing on the Internet, the network peripheral device needs to have a large amount of storage to store a large amount of virus check data. That is, supporting the virus check function increases the memory size and cost of a network peripheral device.

### SUMMARY

Aspects of the present invention are advantageous in that a mail reception system configured such that expansion of viruses can be prevented even if the memory size of a mail relay device is relatively small.

### BRIEF DESCRIPTION OF THE ACCOMPANYING DRAWINGS

FIG. 1 illustrates a system configuration of a mail reception system according to a first embodiment.

FIG. 2 illustrates a block diagram of each of an internet facsimile device and a PC provided in the mail reception system.

FIG. 3 is a flowchart illustrating a mail reception process performed in the mail reception system.

FIG. 4 is a flowchart illustrating a mail transfer control process executed by the network facsimile device.

FIG. 5 is a flowchart illustrating a decoding process executed by the internet facsimile device.

FIG. 6 is a flowchart illustrating a virus detection process executed by the PC.

FIG. 7 is a flowchart illustrating a mail reception process performed in the mail reception system according to a second embodiment.

FIG. 8 is a flowchart illustrating a mail transfer control process executed by the network facsimile device according to the second embodiment.

FIG. 9 is a flowchart illustrating a virus detection process executed by the PC according to the second embodiment.

FIG. 10 is a flowchart illustrating a variation of the mail transfer control process shown in FIG. 4.

### DETAILED DESCRIPTION

1. General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to an aspect of the invention, there is provided a mail reception system comprising a mail relay device having a transferring function of transferring data transmitted from an external device to a predetermined reception device, and a virus check device having a function of virus detection. The virus check device is communicatably connected with the mail relay device. In the mail reception system, the mail relay device comprises a data reception unit configured to receive data from the external device, a data transmission unit configured to transmit the data received by the data reception unit to the virus check device before the data is transferred to the predetermined reception device, and a check result reception unit configured to receive information concerning a result of virus detection from the virus check device. The virus check device comprises a check device side reception unit configured to receive the data from the data transmission unit of the mail relay device, a virus detection unit configured to detect whether a virus is contained in the data received by the check device side reception unit, and a notification unit configured to transmit the information concerning a result of virus detection conducted by the virus detection unit to the mail relay device.

The mail reception system is used, for example, in a situation where a user is on a business trip and is unable to receive data (e.g., facsimile document data, an e-mail or an image data) in the user's office. By setting a user's notebook computer as the predetermined reception device, the mail relay device transmits the data to the virus check device before transferring the data to the user's notebook computer, in response to reception of the data from an external device. The virus check device detects whether a virus is contained in the data from the mail relay device, and transmits the information concerning a result of virus detection to the mail relay device.

Such a configuration enables the mail relay device to know whether a virus is contained in the data, and a user of the mail relay device or the predetermined reception device to pay attention to handling of the data. Since the virus detection is not conducted on the mail relay device but is conducted on the virus check device, it is possible to appropriately conduct the virus detection even if a memory size of the mail relay device is relatively small and the amount of data received by the mail relay device is large. Therefore, expansion of viruses from the mail relay device can be prevented.

In at least one aspect, the mail relay device transfers the information concerning a result of virus detection to the predetermined reception device.

In at least one aspect, the virus check device further comprises a virus elimination unit configured to eliminate a virus from the data transmitted from the mail relay device if the virus is detected by the virus detection unit. In this case, the data from which the virus is eliminated is transmitted from the notification unit of the virus check device to the mail relay device, as at least a part of the information concerning a result of virus detection. The mail relay device transfers the data from which the virus is eliminated to the predetermined reception device.

Such a configuration prevents the data containing a virus from mistakenly opened by the user. Therefore, expansion of viruses can be prevented more reliably.

In at least one aspect, the notification unit of the virus check device transmits a notification indicating that the virus is removed from the data to the mail relay device if the virus elimination unit eliminates the virus from the data. In this case, the mail relay device transfers the notification to the predetermined reception device together with the data from which the virus is eliminated.

Such a configuration enables the user to easily know that the virus is contained in the data transmitted from the mail relay device.

In at least one aspect, the notification unit of the virus check device transmits virus information as to whether a virus is contained in the data to the mail relay device as the information concerning a result of virus detection. The mail relay device further comprises a transfer function disabling unit configured to disable the transferring function of the mail relay device in response to reception of the virus information indicating that a virus is contained in the data.

Because the transfer function disabling unit disables the transferring function if a virus is detected, the expansion of the virus from the mail relay device is securely prevented.

In at least one aspect, the mail relay device further comprises a storage unit in which the data received by the data reception unit is stored and a data deletion unit configured to delete the data stored in the storage unit if the information concerning a result of virus detection indicates that a virus is contained in the data.

With this configuration, even if the mail relay device receives the data containing a worm virus having the function of automatically transferring data to other devices and the data is stored in the mail relay device, the data containing the worm virus is deleted from the storage unit in response to reception of the information indicating that the virus is contained in the data. Such a configuration prevents the data containing a virus from being mistakenly transferred from the mail relay device to other devices. The expansion of viruses from the mail relay device can be securely prevented.

In at least one aspect, the mail relay device is an internet facsimile device having a function of communicating with a device through the Internet. The virus check device is a personal computer.

In at least one aspect, the mail relay device further comprises a state detection unit configured to detect whether the virus check device is in a running state in response to reception of the data from the external device and an activation control unit configured to cause the virus check device to move to the running state if the state detection unit detects that the virus check device is not in the running state.

Such a configuration enables the mail reception system to continue to execute the virus detection even if the user mistakenly turns the virus check device to off. Therefore, reliability of virus detection can be kept at a high level.

In at least one aspect, the mail relay device further comprises a state detection unit configured to detect whether the virus check device is in a running state in response to reception of the data from the external device and a notification mail transmission unit configured such that if the state detection unit detects that the virus check device is not in the running state, the notification mail transmission unit generates a notification mail indicating that virus detection by the virus check device can not be performed and transmits the notification mail to the predetermined reception device.

Such a configuration enables the user to know that there is a possibility that the data from the mail relay device contains a virus by checking the notification mail, and thereby pay attention to handling of the data from the mail relay device. Therefore, reliability of virus detection can be kept at a high level.

In at least one aspect, the data received by the data reception unit and to be transferred to the predetermined reception device comprises at least one of facsimile document data, an e-mail and image data.

According to another aspect of the invention, there is provided a mail relay device communicatably connected to a virus check device having a function of virus detection, the mail relay device having a transferring function of transferring data transmitted from an external device to a predetermined reception device. The mail relay device comprises a data reception unit configured to receive data from the external device, a data transmission unit configured to transmit the data received by the data reception unit to the virus check device before the data is transferred to the predetermined reception device, and a check result reception unit configured to receive information concerning a result of virus detection from the virus check device.

Such a configuration enables the mail relay device to know whether a virus is contained in the data and a user of the mail relay device or the predetermined reception device to pay attention to handling of the data. Since the virus detection is not conducted on the mail relay device but is conducted on the virus check device, it is possible to appropriately conduct the virus detection even if a memory size of the mail relay device is relatively small and the amount of data received by the mail relay device is large. Therefore, expansion of viruses from the mail relay device can be prevented.

In at least one aspect, the mail relay device transfers the information concerning a result of virus detection to the predetermined reception device.

In at least one aspect, the check result reception unit receives the data from which a virus is eliminated by the virus check device. The mail relay device transfers the data from which the virus is eliminated to the predetermined reception device.

Such a configuration prevents the data containing a virus from mistakenly opened by the user. Therefore, expansion of viruses can be prevented more reliably.

In at least one aspect, the check result reception unit receives a notification from the virus check device indicating that the virus is removed from the data, and the mail relay device transfers the notification to the predetermined reception device together with the data from which the virus is eliminated.

Such a configuration enables the user to easily know that the virus is contained in the data transmitted from the mail relay device.

In at least one aspect, the check result reception unit receives virus information as to whether a virus is contained in the data from the mail check device as the information concerning a result of virus detection. The mail relay device further comprises a transfer function disabling unit configured to disable the transferring function in response to reception of the virus information indicating that a virus is contained in the data.

Because the transfer function disabling unit disables the transferring function if a virus is detected, the expansion of the virus from the mail relay device is securely prevented.

In at least one aspect, the mail relay device further comprises a storage unit in which the data received by the data reception unit is stored and a data deletion unit configured to delete the data stored in the storage unit if the information concerning a result of virus detection indicates that a virus is contained in the data.

With this configuration, even if the mail relay device receives the data containing a worm virus having the function of automatically transferring data to other devices and the data is stored in the mail relay device, the data containing the worm virus is deleted from the storage unit in response to reception of the information indicating that the virus is contained in the data. Such a configuration prevents the data containing a virus from being mistakenly transferred from the mail relay device to other devices. The expansion of viruses from the mail relay device can be securely prevented.

In at least one aspect, the mail relay device further comprises a state detection unit configured to detect whether the virus check device is in a running state in response to reception of the data from the external device and an activation control unit configured to cause the virus check device to move to the running state if the state detection unit detects that the virus check device is not in the running state.

Such a configuration enables the mail relay device to continue to execute the virus detection even if the user mistakenly turns the virus check device to off. Therefore, reliability of virus detection can be kept at a high level.

In at least one aspect, the mail relay device further comprises a state detection unit configured to detect whether the virus check device is in a running state in response to reception of the data from the external device, and a notification mail transmission unit configured such that if the state detection unit detects that the virus check device is not in the running state, the notification mail transmission unit generates a notification mail indicating that virus detection by the virus check device can not be performed and transmits the notification mail to the predetermined reception device.

Such a configuration enables the user to know that there is a possibility that the data from the mail relay device contains a virus by checking the notification mail and thereby pay attention to handling of the data from the mail relay device. Therefore, reliability of virus detection can be kept at a high level.

In at least one aspect, the mail relay device is an internet facsimile device having a function of communicating with a device through the Internet.

According to another aspect of the invention, there is provided a computer-usable medium having computer-readable instructions stored thereon, which, when executed by a computer which has a transferring function of transferring data transmitted from an external device to a predetermined reception device and is communicatably connected to a virus check device having a function of virus detection, are configured to receive data from the external device, to transmit the received data from the external device to the virus check device before the data is transferred to the predetermined reception device, and to receive information concerning a result of virus detection from the virus check device.

Such a configuration enables the mail relay device to know whether a virus is contained in the data and a user of the mail relay device or the predetermined reception device to pay attention to handling of the data. Since the virus detection is not conducted on the mail relay device but is conducted on the virus check device, it is possible to appropriately conduct the virus detection even if a memory size of the mail relay device is relatively small and the amount of data received by the mail relay device is large. Therefore, expansion of viruses from the mail relay device can be prevented.

Embodiments

Hereafter, embodiments according to the invention will be described with reference to the accompanying drawings.

First Embodiment

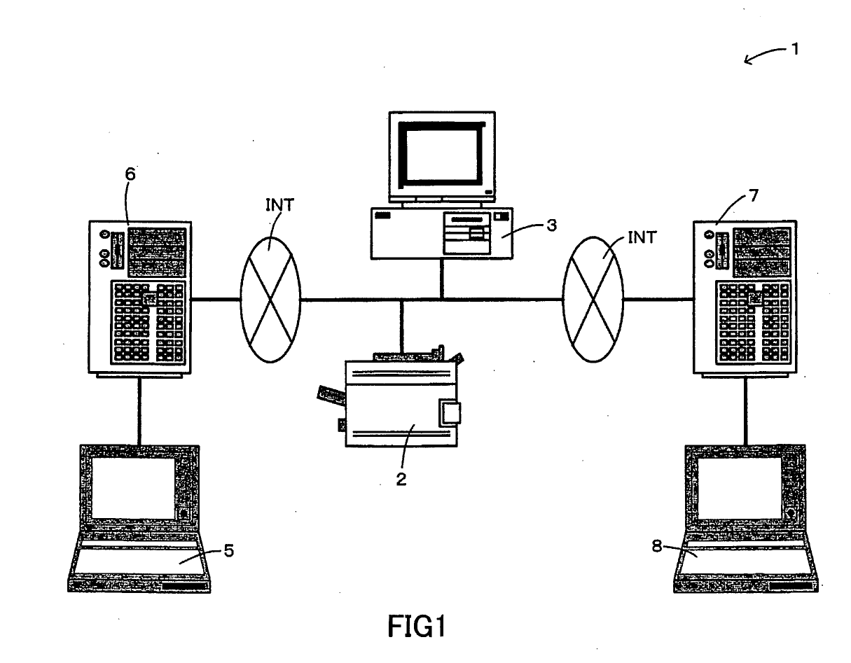

FIG. 1 illustrates a system configuration of a mail reception system 1 according to a first embodiment. The mail reception system 1 includes an internet facsimile device 2 functioning as a mail relay device and a PC (Personal Computer) 3 functioning as a virus check device, which are communicatably connected with each other via a LAN 4. In the mail reception system 1, the internet facsimile device 2 is connected to servers 6 and 7 via the Internet (which is assigned “INT” in FIG. 1). Hereafter, the servers 6 and 7 are referred to as a first server 6 and a second server 7, respectively.

The first server 6 is managed by a service provider with which a user (hereafter, referred to as a user B) has made a contract. The internet facsimile device 2 is owned by the user B. The first server 6 serves to connect the internet facsimile device 2 to the Internet, and to process or store a Web page requested by the internet facsimile device 2 or mail data addressed to the user B. The second server 7 is managed by a service provider with which the user B has made a contract. The second server 7 serves to connect a notebook computer 8 owned by the user B to the Internet, and to process or store a Web page requested by the notebook computer 8 of the user B or mail data addressed to the user B.

The term “mail data” as used herein means data which is usable for representation on a display (e.g., an LCD) of an information processing device, such as a personal computer, a PDA, and a mobile phone. For example, the mail data is facsimile document data, e-mail data, or image data. The mail data includes a “body” in which information (e.g. a document or an image) to be sent from a sender to a destination is contained, a “header” in which a title of a document, a destination address and a source address are contained, and “attached data”.

For example, mail data is treated in the mail reception system 1 as follows. When the internet facsimile 2 receives mail data from a notebook computer 5 owned by another user (hereafter referred to as a user A), the internet facsimile device 2 transmits the received mail data to the PC 3. After receiving the mail data, the PC 3 checks the mail data to detect a virus. Then, the PC 3 transmits information containing a result of virus check to the internet facsimile device 2. In the mail reception system 1, the mail data received by the internet facsimile device 2 is processed on the PC 3 to detect a virus. The internet facsimile device 2 treats the mail data in accordance with the result of virus check contained in the information from the PC 3.

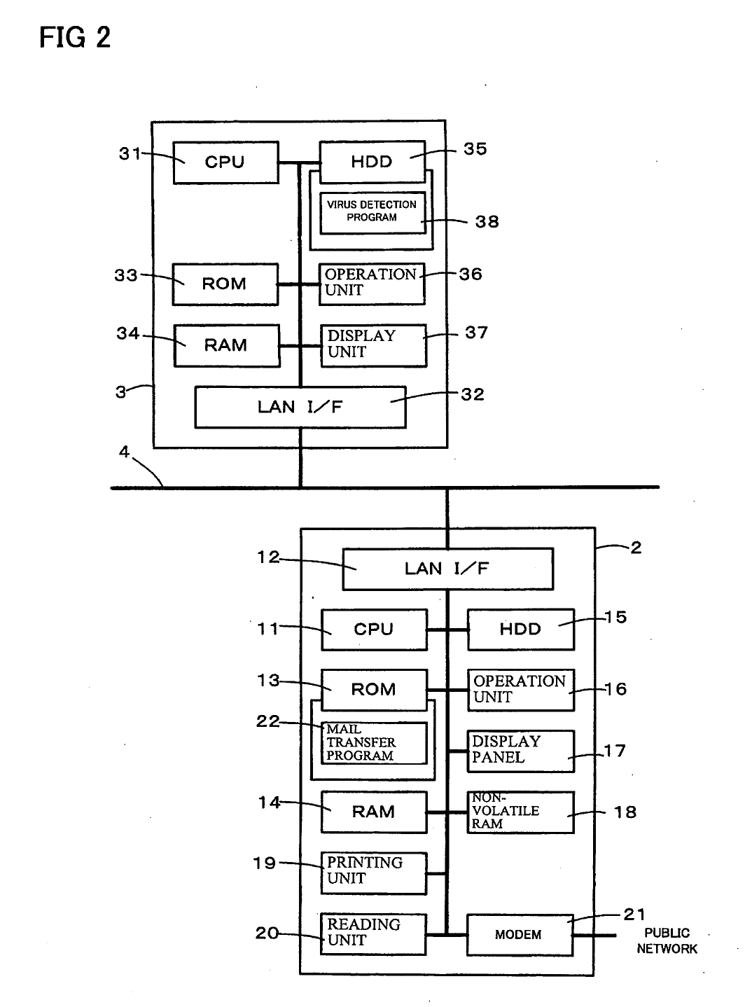

FIG. 2 illustrates a block diagram of each of the internet facsimile device 2 and the PC 3. The internet facsimile device 2 is configured to be a multifunction device including a telephone function, a facsimile function, a coping function, a printing function, a scanner function, and a mailing function. The internet facsimile device 2 is connected to a public network via a modem 21 and is connected to the Internet via a LAN interface 12. As shown in FIG. 2, the internet facsimile device 2 includes a CPU (Central Processing Unit) 11, a ROM 13, a RAM 14, an HDD (Hard Disk Drive) 15, an operation unit 16, a display panel 17, a non-volatile RAM 18, a printing unit 19, a reading unit 20, the modem 21 and the LAN interface 12, which are connected to each other via an internal bus.

The CPU 11 controls the functions of the internet facsimile device 2. The LAN interface 12 interfaces the internet facsimile device 2 with a device (e.g., the PC 3) on the LAN 4. In the RAM 13, various programs to be executed by the CPU 11 are stored. For example, a mail transfer program 22 is stored in the ROM 13. When executed by the CPU 11, the mail transfer program 22 causes the internet facsimile device 2 to receive mail data from an external device, to transmit the received mail data to the PC 3, to receive information containing the result of virus check from the PC3, and then to execute a process, such as printing or transferring, in accordance with the result of virus check.

The RAM 14 is used as a work memory to temporarily store data when the CPU 11 processes data. The HDD 15 is used to store various types of data. The operation unit 16 includes keys (e.g., buttons, a touch panel, or an operation stick) to be operated by the user of the internet facsimile device 2. The display panel 17 is, for example, an LCD having a touch panel, on which various types of information, such as a facsimile image or mail data, are displayed.

The non-volatile RAM 18 is used to store information to be maintained during a power-off state of the internet facsimile device 2. In this embodiment, the mail data received by the internet facsimile device 2 is stored in the non-volatile RAM 18.

The printing unit 19 prints an image corresponding to facsimile document data, image data, email data or document data on a recording medium, such as a sheet of paper or a transparency. The reading unit 20 has functions of reading an original to obtain image data and reading data stored on a storage medium such as a CD or a memory stick. The modem 21 connected to the public network has the function of converting digital information to sound data (or sound data to digital information).

The PC 3 functioning as a virus check device includes a CPU 31, a LAN interface 32, a ROM 33, a RAM 34, an HDD 35, an operation unit 36, and a display unit 37, which are connected to each other via an internal bus. The CPU 31 controls internal components and processes various types of data. The LAN interface 32 interfaces the PC 3 with an external device (e.g., the internet facsimile device 2) via the LAN 4. In the ROM 33, various types of data and programs are stored. The RAM 34 is used as a work memory to temporarily store data when the CPU 31 processes data. The HDD 35 is used to store various types of data including data received from an external device. In this embodiment, mail data from the internet facsimile device 2 and a virus detection program 38 are stored in the HDD 35.

When executed by the CPU 31, the virus detection program 38 causes the PC 3 to process the mail data from the internet facsimile device 2 to detect a virus and to transmit the information containing the result of virus check to the internet facsimile device 2. The operation unit 36 is, for example, a mouse and a keyboard. On the display unit 37, various types of information, such as a processing result by the CPU 31, are displayed.

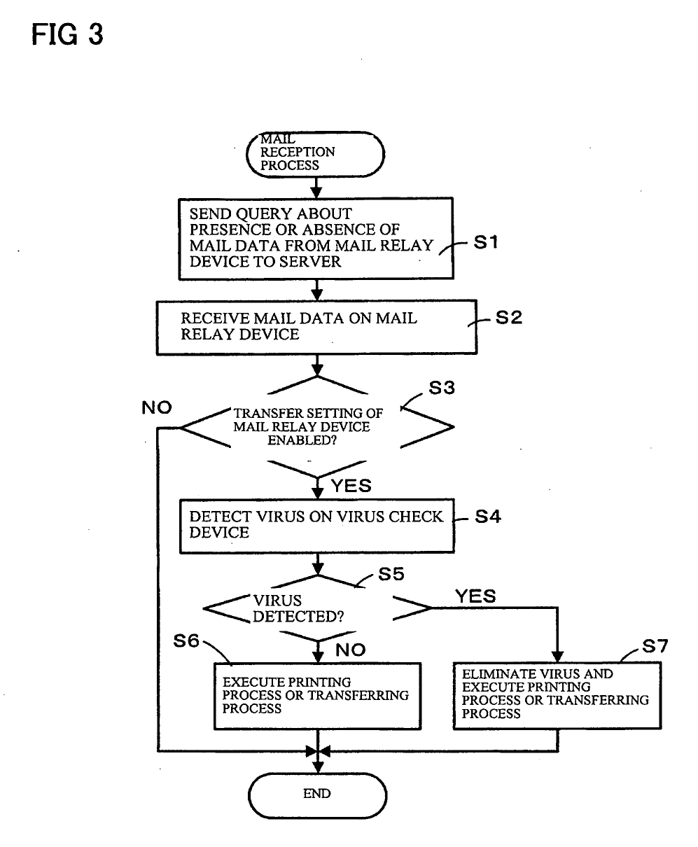

FIG. 3 is a flowchart illustrating a mail reception process performed in the mail reception system 1. The mail reception process is initiated when the internet facsimile device 2 transmits a query about presence or absence of mail data to the first server 6. The query may be issued from the internet facsimile device 2 in response to a user operation conducted by the user or may by automatically issued repeatedly at predetermined time intervals.

In step S1, the query is transmitted from the internet facsimile device 2 to the first server 6. After receiving the query, the first server 6 checks for the presence or absence of mail data (e.g., e-mail) addressed to the user of the internet facsimile device 2. If the mail data (e.g., a e-mail) addressed to the user of the internet facsimile device 2 is found, the first server 6 transmits the mail data to the internet facsimile device 2 via the Internet.

Next, in step S2, the internet facsimile device 2 receives the mail data from the first server 6. Then, in step S3, the internet facsimile device 2 judges whether transfer setting is enabled. The transfer setting is enabled or disabled on the internet facsimile device 2. For example, the transfer setting may be enabled or disabled manually by the user or the transfer setting may be automatically enabled in accordance with a predetermined time schedule. If the transfer setting is not enabled (S3: NO), the mail reception process terminates without transferring the mail data or executing a print process on the mail data.

If the transfer setting is enabled (S3: YES), the virus check is performed on the PC 3 which received the mail data from the internet facsimile device 2 (step S4). Next, in step S5, the internet facsimile device 2 checks whether a virus is detected in the mail data in accordance with the result of virus check from the PC 3. If the internet facsimile device 2 judges that a virus is not detected in the mail data (S5: NO), a printing process or a transferring process is executed for the mail data (step S6). If the internet facsimile device 2 judges that a virus is detected in the mail data (S5: YES), the internet facsimile device 2 executes the print process or the transferring process on the mail data from which the virus is eliminated.

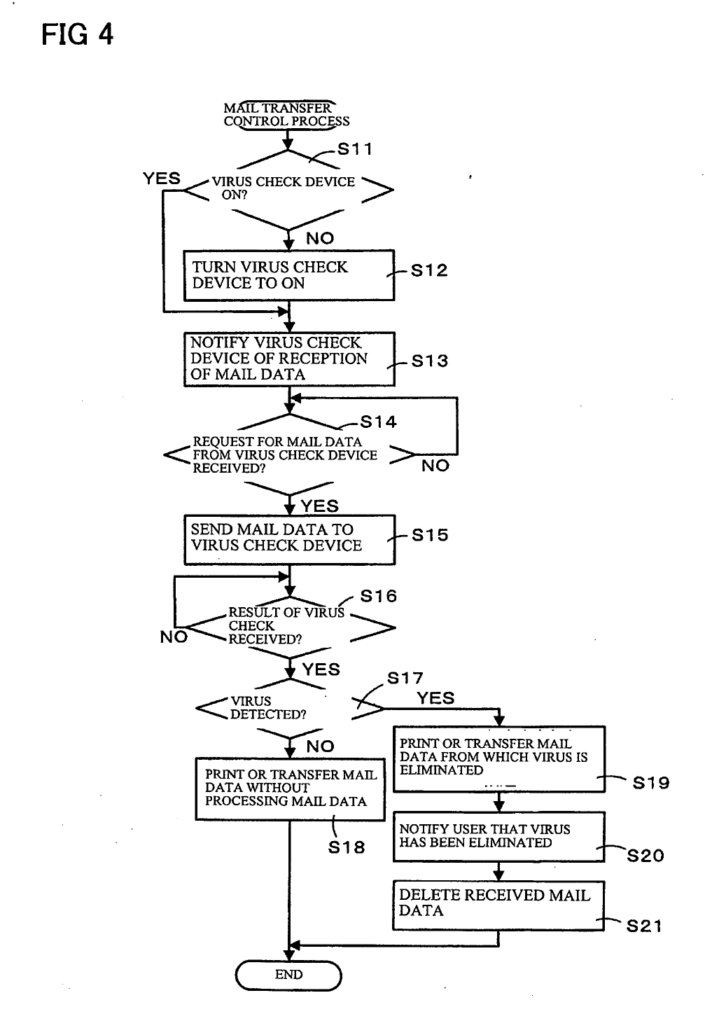

Hereafter, operations of the internet facsimile device 2 and the PC 3 are explained in detail. FIG. 4 is a flowchart illustrating a mail transfer control process executed by the network facsimile device 2. The mail transfer control process is initiated when the internet facsimile device 2 receives the mail data.

As shown in FIG. 4, first, the CPU 11 of the internet facsimile device 2 checks whether power of the PC3 (the virus check device) is ON, for example, by transmitting an activation check signal to the PC 3 and thereafter judging whether a response to the activation check signal is received from the PC3. If the power of the PC3 is ON (S11 YES), control proceeds to step S13. If the power of the PC3 is OFF (S11: NO), the internet facsimile device 2 causes the PC 3 to move to a power-on state.

Next, in step S13, the CPU 11 transmits a mail reception signal to the PC 3 to notify the PC 3 of reception of a mail. Next, in step S14, the CPU 11 judges whether a request for mail data transmitted from the PC 3 is received. The CPU 11 waits until the request is received (S14:NO) so as to allow the PC 3 to move to a state where the PC 3 is ready for reception of the mail data.

If the request for mail data from the PC 3 is received (S14: YES), the CPU 11 reads the mail data from the non-volatile RAM 18 (which stores the mail data when the mail data is received by the internet facsimile device 2), and transmits the mail data to the PC 3 (step S15). Next, in step S16, the CPU 11 judges whether information containing a result of virus check from the PC 3 is received. The CPU 11 waits until the information containing the result of virus check is received (S16: NO) so as to securely obtain the result of the virus check of the PC 3. If the information containing the result of virus check is received (S16: YES), the CPU 11 judges whether a virus is contained in the mail data in accordance with the information form the PC 3 (step S17).

If no virus is contained in the mail data (S17: NO), a print process for printing an image corresponding to the mail data or a transferring process for transferring the mail data to a predetermined destination is executed (step S18). If a virus is detected in the mail data (S17; YES), control proceeds to step S19 where the CPU 11 processes the mail data from which the virus is eliminated (i.e., prints an image corresponding to the mail data or transfers the mail data to a predetermined destination). By this configuration, even if a virus is contained in the mail data when the mail data is received by the internet facsimile device 2, the virus can be secured and eliminated from the mail data before the mail data is transferred to the predetermined destination.

Next, in step S20, a notification indicating that a virus is eliminated from the mail data is displayed, for example, through the display panel 17, to notify the user of completion of elimination of the virus before transferring of the mail data to the predetermined destination. In step S21, the CPU 11 removes the mail data from the non-volatile RAM 18. As described above, the mail data is stored in the non-volatile RAM 18 so that the mail data is maintained during the power-off state of the internet facsimile device 2. Therefore, if mail data containing a virus is maintained in the non-volatile RAM 18, a possibility that the user erroneously transmits the mail data containing a virus to a device (e.g. the notebook computer 8) arises. For this reason, in step S21, the mail data containing the virus is removed from the non-volatile RAM 18.

The internet facsimile device 2 has the function of decoding the mail data received from an external device and printing an image (a message, a document, etc.) corresponding to the decoded data. As described above, the mail data includes a header, a body and attached data. In the header, important information concerning mail communication, such as a sender, a destination, names of relaying devices, and a subject, is contained. In the body, information to be provided to a user of the destination is contained. The attached data is used, for example, to send binary data to the destination, along with a text-based mail message. Such binary data is converted to text codes. Frequently, attached data is used for the wrong purpose such as a breeding area for a worm. Therefore, in general, users of a mailing system need to carefully handle attached data of which safety has not been checked. For this reason, the internet facsimile device 2 executes a printing process for the mail data in accordance with a print condition which the internet facsimile device 2 allows the user to designate through the operation unit 16.

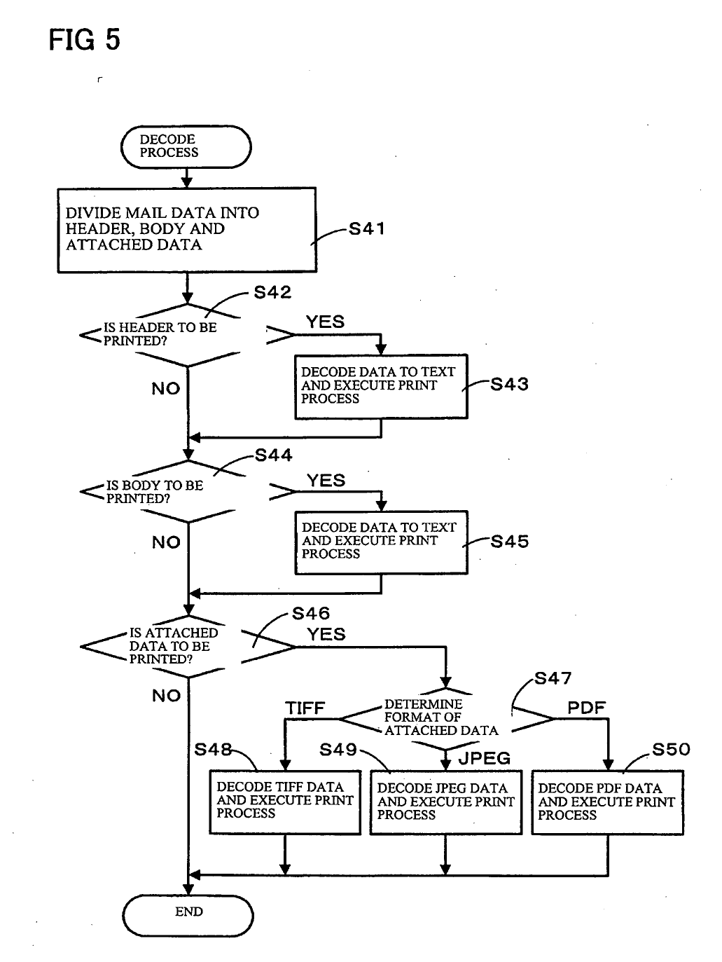

FIG. 5 is a flowchart illustrating a decoding process executed under control of the CPU 11 of the internet facsimile device 2. First, in step S41, the CPU 11 divides the mail data transmitted from the PC 3 into a header, a body and attached data. Then, the CPU 11 judges whether to print the header (step S42). If settings (which are set to the internet facsimile device 2 in advance) indicate that printing of the header is not enabled (S42: NO), control proceeds to step S43. If the settings indicate that printing of the header is to be printed (S42: YES), decoding of data to text and a print process are executed (step S43). If the settings are made such that only a limited part (e.g., information concerning a sender and a subject) in the header is allowed to be printed, the print process in step S43 may be executed only for the limited part in the header. Then, control proceeds to step S44.

Next, in step S44, the CPU 11 judges whether to print the body. If the settings indicate that printing of the body is not to be printed (S44: NO), control proceeds to step S46. If the settings indicate that printing of the body is to be printed (S44: YES), decoding of data to text and a print process for the body are executed (step S45). Then, control proceeds to step S46.

In step S46, the CPU 11 judges whether to print the attached data. If the settings indicate that printing of attached data is not to be printed (S46: NO), the decoding process terminates. If the settings indicate that printing of attached data is to be printed (S46: YES), the CPU 11 identifies a format of the attached data in accordance with information on the format of the attached data contained in the mail data (step S47).

If the format of the attached data is a TIFF format (S47: TIFF), decoding of TIFF data and a print process are executed (step S48). If the format of the attached data is a JPEG format (S47: JPEG), decoding of JPEG data and a print process are executed (step S49). If the format of the attached data is a PDF format (S47: PDF), decoding of PDF data and a print process are executed (step S50).

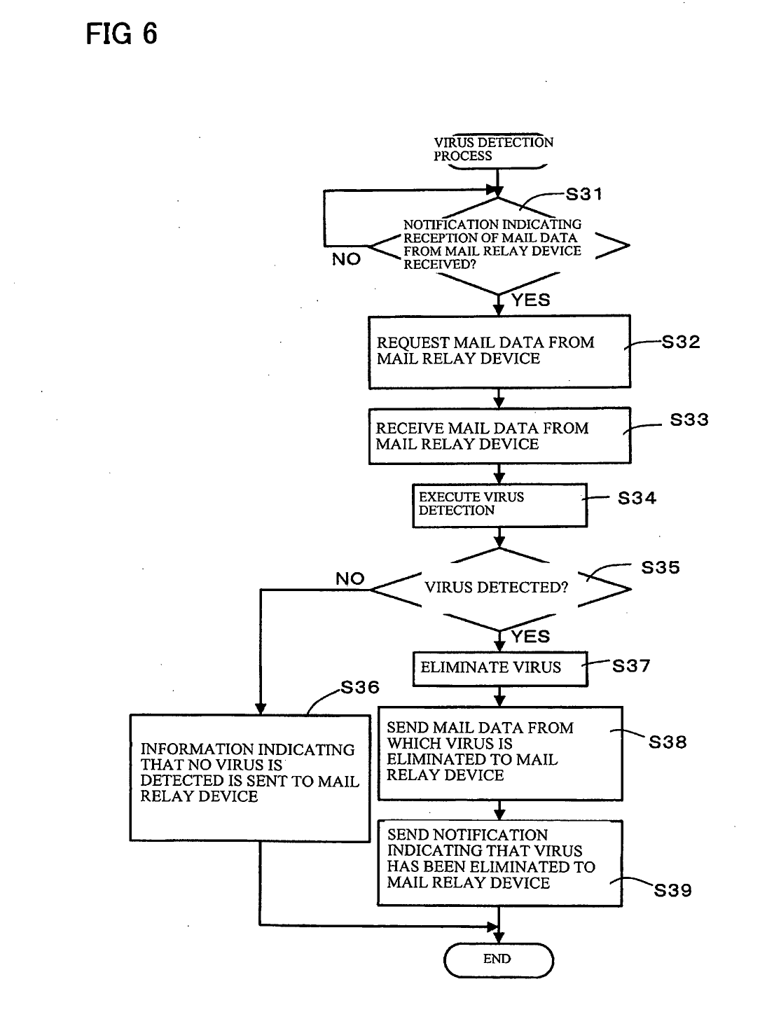

Hereafter, a virus detection process (corresponding to the virus detection program 38) executed by the CPU 31 of the PC 3 is described with reference to FIG. 6. The virus check process is initiated when the PC 3 receives mail data from the internet facsimile device 2.

First, the CPU 31 judges whether a notification indicating reception of mail data on the internet facsimile device 2 is received by judging whether the mail reception signal is received (step S31). The PC 3 waits until the notification from the internet facsimile device 2 is not received (S31: NO). If the notification from the internet facsimile device 2 is received (S31: YES), the CPU 31 transmits a request signal to the internet facsimile device 2 to request the mail data from the internet facsimile device 2 (step S32). Next, in step S33, the PC 3 receives the mail data from the internet facsimile device 2 through the LAN 4, and stores it in the HDD 35. Then, the CPU 31 checks whether a virus is detected in the mail data (step S34).

Various ways of detecting viruses can be employed in the detection process in step S34. For example, a table listing the types of viruses may be stored in advance in the HDD 35. In this case, the PC 3 is able to detect a virus by judging whether a virus stored in the table is contained in the mail data while checking the mail data against data in the table.

In step S35, the PC 3 judges whether a virus is contained in the mail data (step S35). If no virus is contained in the mail data (S35: NO), the PC 3 generates a notification indicating that no virus is contained in the mail data and transmits the notification to the internet facsimile device 2 (step S36). Then, the virus detection process terminates.

If a virus is contained in the mail data (S35: YES), the PC 3 generates a result of virus check indicating that a virus is contained in the mail data and transmits information containing the result of virus check to the internet facsimile device 2 (step S37). More specifically, the CPU 31 executes virus elimination software to eliminate the virus from the mail data (S37), and then transmits the mail data from which the virus is eliminated to the internet facsimile device 2 (S38). Next, in step S39, the CPU 11 transmits a notification indicating that a virus was contained in the mail data to the internet facsimile device 2. Then, the virus detection process terminates.

Hereafter, an example of an application of the mail reception system 1 is explained. Assume a case where facsimile document data is transmitted to the user B from the user A (business partner) during the user B's absence in the user B's office, and the facsimile document data is transmitted to the notebook computer 8 owned by the user B.

Before making a business trip, the user B operates the internet facsimile device 2 to set the notebook computer 8 as a destination of transfer of facsimile data. The user A generates facsimile document data on the notebook computer 5 and then connects the notebook computer 5 to a server (not shown) of a service provider with which the user A has made a contract to transmit the facsimile document data to the user B via the Internet. The facsimile document data is transmitted from the server of the service provider of the user A to the first server 6 of the service provider of the user B via relaying servers on the Internet and is stored in the first server 6 temporarily. The internet facsimile device 2 works on a 24-hour basis, and periodically transmits a query on whether mail data addressed to the user B is received, to the first server 6 (see S1 in FIG. 3).

If the facsimile document data transmitted from the user A to the user B is stored in the first server 6, the first server 6 transmits the facsimile document data to the internet facsimile device 2 through the Internet. Then, the internet facsimile device 2 receives the facsimile document data sent out by the user A. The internet facsimile device 2 transmits the facsimile document data to the PC 3 before transferring the facsimile document data to the notebook computer 8 set as the destination in advance (see S15 in FIG. 4).

After receiving the facsimile document data from the internet facsimile device 2, the PC 3 checks the facsimile document data to judge whether a virus is contained in the facsimile document data, generates information containing a result of virus check, and transmits the information to the internet facsimile device 2 (see S4 in FIG. 3 and S35 to S39 in FIG. 6).

The internet facsimile device 2 transmits the information containing the result of virus check to the notebook computer 8 in response to receipt of the information containing the result of virus check from the PC 3 (S16:YES, S17 to S20 in FIG. 4). More specifically, if the internet facsimile device 2 judges that the mail data does not contain a virus, the internet facsimile device 2 transmits the mail data without processing the mail data (S17: NO, S18 in FIG. 4). On the other hand, if the internet facsimile device 2 judges that the mail data contains a virus, the internet facsimile device 2 transmits the mail data from which the virus is eliminated to the notebook computer 8 together with a notification indicating that a virus has been eliminated from the mail data (S17: YES, S19 and S20 in FIG. 4).

Therefore, the user B is able to know whether the facsimile document data transferred from the internet facsimile device 2 to the notebook computer 8 contains a virus by checking whether the notification indicating that a virus has been eliminated is received. The user B is also able to handle the facsimile document data with being aware of the fact that the mail data does not contain a virus.

As described above, the virus detection is not executed on the internet facsimile device 2 but is executed on the PC 3. Such a configuration makes it possible to securely detect a virus even if a mail relay device (i.e., the internet facsimile device) having a small memory size receives a large amount of facsimile document data. Consequently, viruses are prevented from infecting another device (e.g., the notebook computer 8). It is understood that such an advantage of the embodiment is emphasized in a situation where data size of antivirus software and virus pattern data for such software is too large to store in the internet facsimile device 2 having a memory size which is in general smaller than that of a personal computer.

According to the mail reception system 1, if a virus is contained in facsimile document data, the PC 3 eliminates a virus from the facsimile document data, and then transmits the facsimile document data to the internet facsimile device 2 (see S37, S38 in FIG. 6). Then, the internet facsimile device 2 transmits the facsimile document data from which the virus has been eliminated, to the notebook computer 8 (see S7 in FIG. 3, S19 in FIG. 4). Such a configuration prevents the facsimile document data containing a virus from being opened by the user B and thereby infecting the internet facsimile device 2 and the notebook computer 8. Consequently, expansion of viruses can be prevented.

The PC 3 transmits the notification indicating that the virus has been eliminated, to the internet facsimile device 2 together with the facsimile document data from which the virus has been eliminated (see S39 in FIG. 4). Then, the internet facsimile device 2 transmits the facsimile document data (from which the virus has been eliminated) and the notification (indicating that the virus has been eliminated) to the notebook computer 8 (see S19, S20 in FIG. 4). Such a configuration enables the user B to easily know that that the virus was contained in the facsimile document data and has been eliminated from the facsimile document data.

In the above mentioned mail reception system 1, the internet facsimile device 2 transmits mail data (which was transmitted from an external device) to the PC 3, and stores the mail data in the non-volatile RAM 18. If the internet facsimile device 2 receives the notification indicating that a virus is contained in the mail data from the PC 3, the internet facsimile device 2 deletes the mail data from the non-volatile RAM 18. Even if the internet facsimile device 2 receives mail data containing a worm virus having the function of randomly transmitting the mail data containing the virus to other devices and then stores the mail data in the non-volatile RAM 18, the internet facsimile device 2 is able to delete the mail data stored in the non-volatile RAM 18 in response to reception of the notification indicating that the virus was contained in the mail data from the PC 3. Consequently, no virus remains in the internet facsimile device 2.

By contrast, if the internet facsimile device is configured not to delete the mail data containing a virus, a possibility that mail data containing a virus is mistakenly transferred to another device by the user arises. According to the embodiment, such a mistake can be prevented from occurring on the internet facsimile device 2. That is, the internet facsimile device 2 is prevented from infecting other devices on a network.

In the mail reception system 1, the virus detection is not conducted on the internet facsimile device 2 but is conducted on the PC 3 connected to the internet facsimile device 2 via the LAN 4. The internet facsimile device 2 works on a 24-hour basis to be able to constantly receive a call or facsimile data, while the PC 3 does not work on a 24-hour basis. If the PC 3 is not running (e.g., in a power-off state or a power saving mode), the virus detection can not be conducted. To avoid such a drawback that the virus detection can not be conducted, the internet facsimile device 2 checks whether power of the PC 3 is ON (i.e., whether the PC 3 is running) when the internet facsimile device 2 receives facsimile document data (see S11 in FIG. 4).

If the internet facsimile device 2 judges that the PC 3 is not running, the internet facsimile device 2 causes the PC 3 to move to a power-on state (see S11: NO, S12 in FIG. 4). Such a configuration enables the internet facsimile device 2 to cause the PC 3 to conduct the virus detection even if the PC 3 was turned to OFF by the user B by mistake. Therefore, according to the embodiment, the reliability of virus detection can be enhanced.

It should be noted that, according to the embodiment, urgent facsimile document data received by the internet facsimile device 2 can be quickly subjected to the virus detection on the PC 3 because the internet facsimile device 2 is able to cause the PC 3 to move to a running state if the internet facsimile device 2judges that the PC 3 is not running. There is no need to execute the virus detection on a device (e.g., the notebook computer 8) different from the PC 3 even if the PC 3 was tuned to off by mistake. It is understood that, according to the embodiment, the virus detection can be performed on a device (i.e., the internet facsimile device 2) located at a gateway of facsimile or mail data.

Second Embodiment

Hereafter, a second embodiment of the invention is described. Since a system configuration of a mail reception system according to the second embodiment is substantially the same as that of the first embodiment, FIG. 1 is used to explain the second embodiment. In the following explanations and drawings, to elements and steps which are the same as those of the first embodiment, the same reference and step numbers are assigned, and explanations thereof will not be repeated.

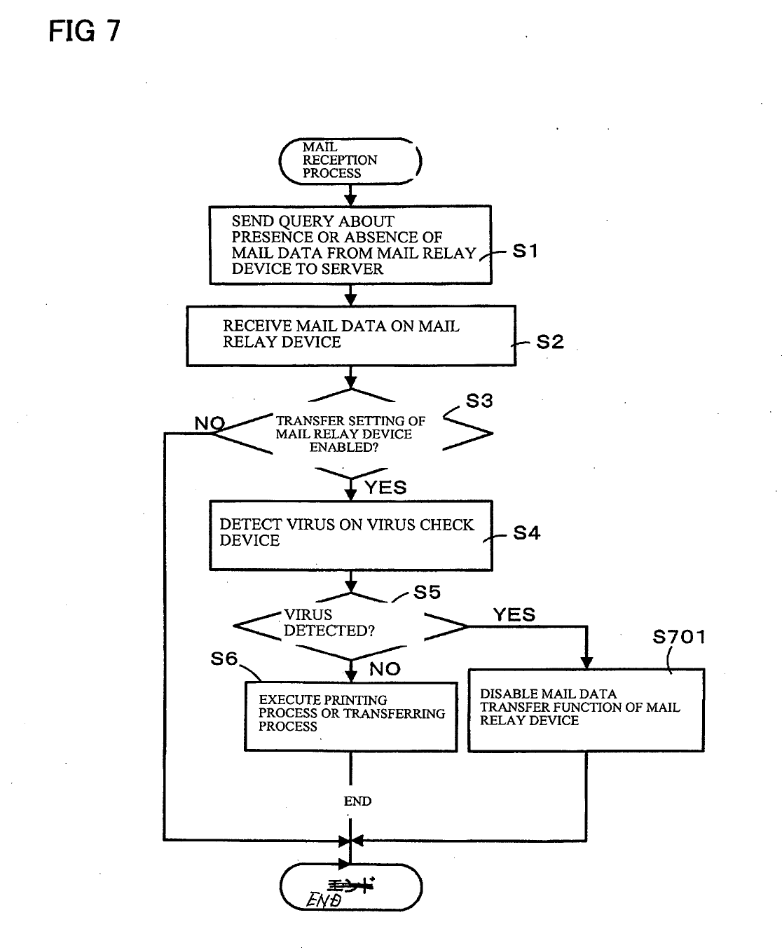

FIG. 7 is a flowchart illustrating a mail reception process performed in the mail reception system 1 according to the second embodiment. As shown in FIG. 7, in this embodiment, if the internet facsimile device 2judges that a virus is contained in mail data based on a result of virus check on the PC 3 (S5: YES), a mail data transfer function, which is implemented on the internet facsimile device 2 to transfer mail data to another device, is disabled (step S701). Then, the mail reception process terminates.

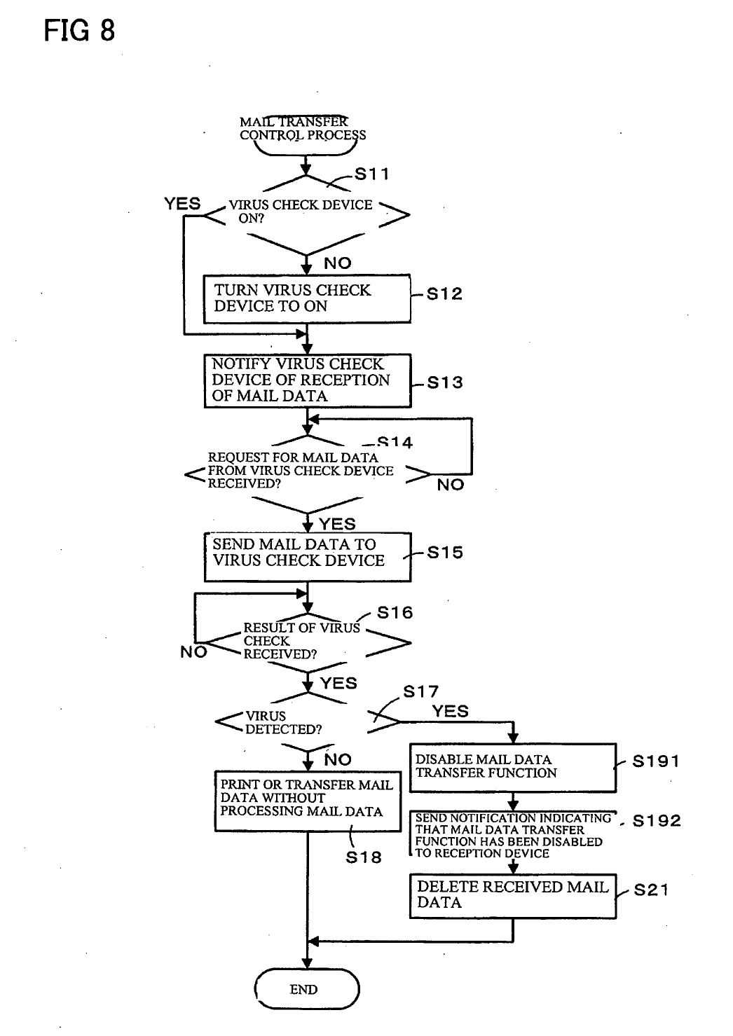

FIG. 8 is a flowchart illustrating a mail transfer control process executed by the network facsimile device 2 according to the second embodiment. As shown in FIG. 8, if the internet facsimile device 2 judges that a virus is contained in the mail data (S1 7: YES), the internet facsimile device 2 disables the mail data transfer function (step S191). After step S191 is processed, mail data sent by the user A is prevented from being transferred from the internet facsimile device 2 to the PC 3, and also another mail data is prevented from being transferred to other devices on the LAN 4 or the Internet.

Next, in step S192, the internet facsimile device 2 generates a mail data transfer function stop notification indicating that the mail data transfer function of the internet facsimile device 2 is disabled and transmits the mail data transfer function stop notification to the notebook computer 8. By this configuration, the user B on the notebook computer 8 is able to know that the internet facsimile device 2 has moved to a state of not transferring mail data to the notebook computer 8.

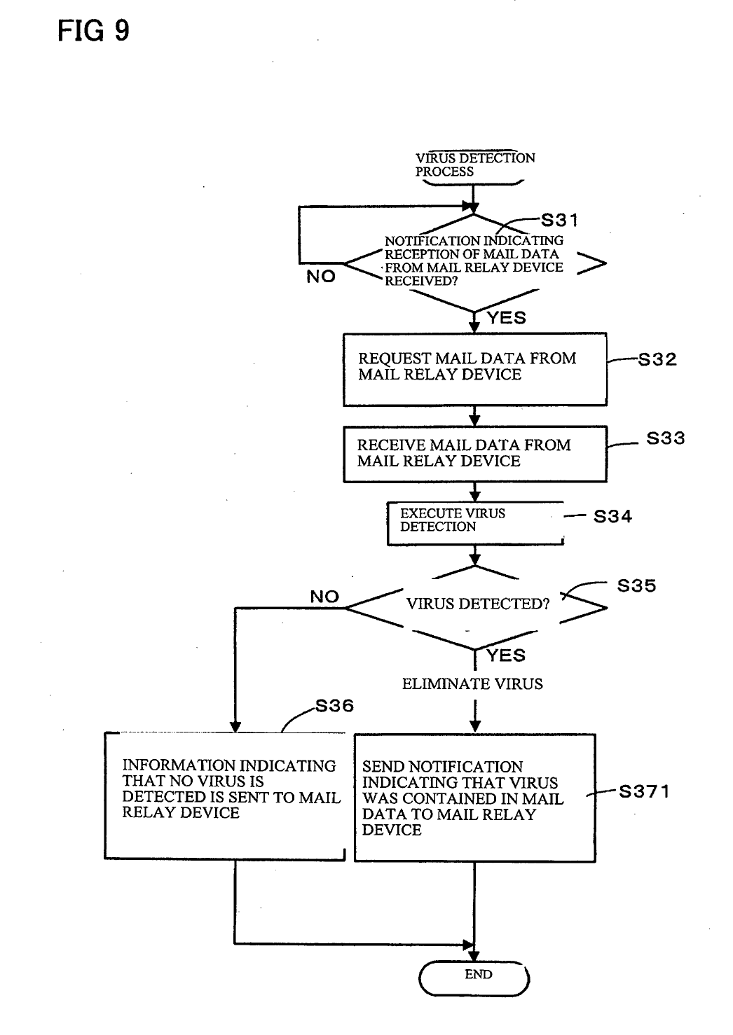

FIG. 9 is a flowchart illustrating a virus detection process executed by the PC 3 according to the second embodiment. As shown in FIG. 9, if the PC 3 detects a virus in the mail data from the internet facsimile device 2 (S35: YES), the PC 3 generates information indicating that a virus is contained in the mail data from the internet facsimile device 2 and transmits the information to the internet facsimile device 2 without eliminating the virus from the mail data. That is, the PC 3 only notifies the internet facsimile device 2 of the fact that the virus is contained in the mail data. Such a configuration eliminates the need for storing and executing virus elimination software on the PC 3. Therefore, a processing load on the PC 3 is reduced.

In the mail reception system 1 according to the second embodiment, the PC 3 notifies the internet facsimile device 2 of information as to whether a virus is contained in mail data received by the internet facsimile device 2 (see S371 in FIG. 9). After receiving the information indicating that a virus is contained in the mail data, the internet facsimile device 2 disables the mail data transfer function (see S701 in FIG. 7, S191 in FIG. 8). In this case, the internet facsimile device 2 moves to a state of being unable to transfer mail data to other devices on the Internet or the LAN 4. Therefore, viruses that arrive at the internet facsimile device 2 are prevented from expanding from the internet facsimile device 2.

Although the present invention has been described in considerable detail with reference to certain preferred embodiments thereof, other embodiments are possible.

For example, although in the above mentioned embodiment the query about presence or absence of mail data is transmitted from the internet facsimile device 2 to the first server 6, and thereafter the mail data is transmitted from the first server 6 to the internet facsimile device 2, the first server 6 may be configured to request transmission of mail data to the internet facsimile device 2. In this case, the internet facsimile device 2 is able to receive mail data from the first server 6 in response to the request from the first server 6.

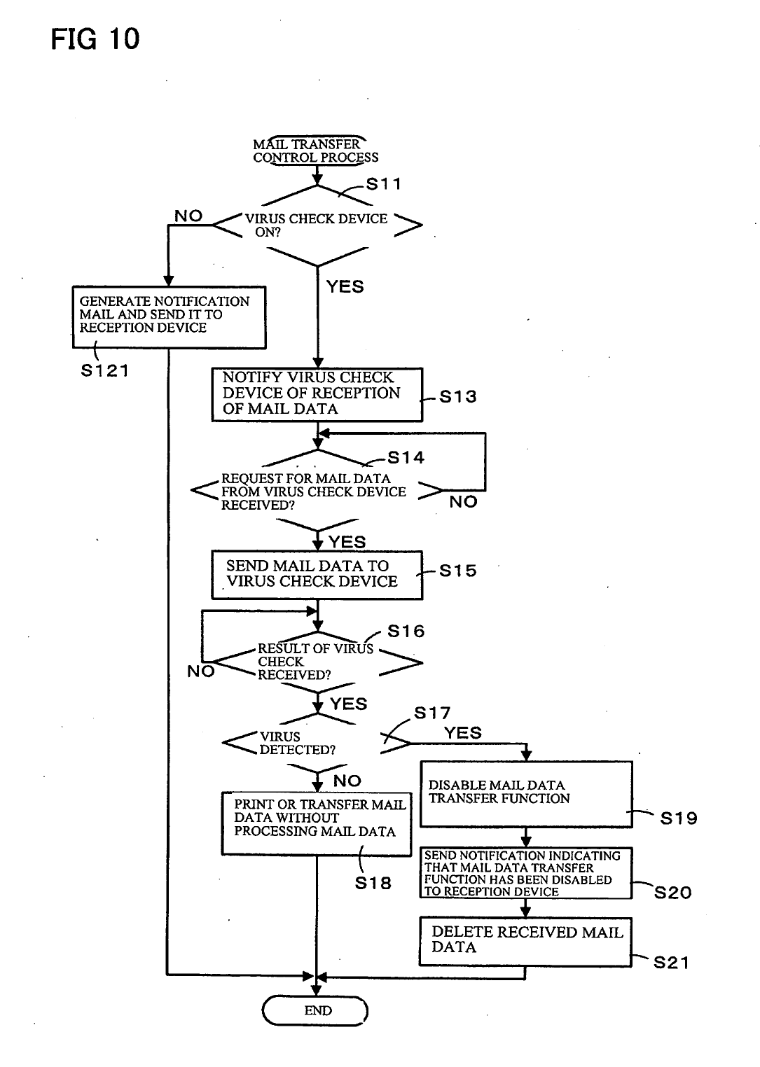

In the above mentioned embodiment, the internet facsimile device 2 has the function of causing the PC 3 to move to a power-on state when execution of the virus check is necessary (see S11, S 12 in FIG. 4). However, if the internet facsimile device 2 detects that the PC 3 is in a power-off state in step S11 of the mail transfer control process, the internet facsimile device 2 may be configured to generate a notification mail to be addressed to the user B (the notebook computer 8) so as to notify the use B of the fact that the mail reception system is in a state of being unable to perform virus detection. Such a variation of the mail transfer control process is illustrated in FIG. 10.

As shown in FIG. 10, if the internet facsimile device 2 judges that the PC 3 is in a power-off state (S11: NO), a notification mail indicating that the virus detection can not be performed is transferred to the notebook computer 8, together with the mail data (step S121). In this case, the user B is able to know that there is a possibility that a virus is contained in the mail data by checking the notification mail from the internet facsimile device 2. Such a configuration causes the user B to pay attention to handling of the mail data. Therefore, the configuration shown in FIG. 10 prevents the mail data containing a virus from being mistakenly opened by the user B and the virus from infecting the notebook computer 8. Therefore, expansion of viruses can be prevented.

In the above mentioned embodiment, the internet facsimile device 2 functions as the mail relay device. However, in the mail reception system, various types of devices having the mailing function may be employed as the mail relay device. For example, a printer having a mailing function may be employed as a mail relay device.

In the above mentioned embodiment, the personal computer (PC 3) is used as the virus check device. However, in the mail reception system, a dedicated device having the virus detection function may be employed as the virus check device.

In the above mentioned embodiment, the notebook computer is used as a reception device for receiving mail data transferred from the mail relay device. However, in the mail reception system, various types of devices having the communication function (e.g., a PDA or a mobile phone) may be employed as the reception device.

In the above mentioned embodiment, the internet facsimile device 2 and the PC 3 are connected to each other via the LAN 4. However, in the mail reception system, the internet facsimile device 2 and the PC 3 may be connected to each other via a different type of communication interface (e.g., a USB (Universal Serial Bus)).

In the above mentioned embodiment, the notification indicating that a virus is contained in mail data is transmitted when the mail data is transferred. However, in the mail reception system, the information containing the result of virus check may be transmitted to a transfer target device when the printing for the mail data is performed so that a user of the transfer target device is able to know that a virus is contained in the mail data. If there is a possibility that the mail relay device is infected, the user of the transfer target device is able to reject reception of the mail data from the mail relay device so that the transfer target device is prevented from being infected with the virus and that the expansion of the virus is prevented.

What is claimed is:

1. A mail reception system, comprising:
a mail relay device having a transferring function of transferring data transmitted from an external device to a predetermined reception device; and
a virus check device having a function of virus detection, the virus check device being communicatably connected with the mail relay device;
the mail relay device comprising:
a data reception unit configured to receive data from the external device;
a data transmission unit configured to transmit the data received by the data reception unit to the virus check device before the data is transferred to the predetermined reception device; and
a check result reception unit configured to receive information concerning a result of virus detection from the virus check device,
the virus check device comprising:
a check device side reception unit configured to receive the data from the data transmission unit of the mail relay device;
a virus detection unit configured to detect whether a virus is contained in the data received by the check device side reception unit; and
a notification unit configured to transmit the information concerning a result of virus detection conducted by the virus detection unit to the mail relay device.

2. The mail reception system according to claim 1,
wherein the mail relay device transfers the information concerning a result of virus detection to the predetermined reception device.

3. The mail reception system according to claim 1,
wherein the virus check device further comprises:
a virus elimination unit configured to eliminate a virus from the data transmitted from the mail relay device if the virus is detected by the virus detection unit,
wherein the data from which the virus is eliminated is transmitted from the notification unit of the virus check device to the mail relay device, as at least a part of the information concerning a result of virus detection,
wherein the mail relay device transfers the data from which the virus is eliminated to the predetermined reception device.

4. The mail reception system according to claim 3, wherein:
the notification unit of the virus check device transmits a notification indicating that the virus is removed from the data to the mail relay device if the virus elimination unit eliminates the virus from the data; and
the mail relay device transfers the notification to the predetermined reception device together with the data from which the virus is eliminated.

5. The mail reception system according to claim 1,
wherein the notification unit of the virus check device transmits virus information as to whether a virus is contained in the data to the mail relay device, as the information concerning a result of virus detection,
wherein the mail relay device further comprises:
a transfer function disabling unit configured to disable the transferring function of the mail relay device in response to reception of the virus information indicating that a virus is contained in the data.

6. The mail reception system according to claim 1,
wherein the mail relay device further comprises:
a storage unit in which the data received by the data reception unit is stored; and
a data deletion unit configured to delete the data stored in the storage unit if the information concerning a result of virus detection indicates that a virus is contained in the data.

7. The mail reception system according to claim 1, wherein:
the mail relay device is an internet facsimile device having a function of communicating with a device through the Internet; and
the virus check device is a personal computer.

8. The mail reception system according to claim 1,
wherein the mail relay device further comprises:
a state detection unit configured to detect whether the virus check device is in a running state in response to reception of the data from the external device; and
an activation control unit configured to cause the virus check device to move to the running state if the state detection unit detects that the virus check device is not in the running state.

9. The mail reception system according to claim 1,
wherein the mail relay device further comprises:
a state detection unit configured to detect whether the virus check device is in a running state in response to reception of the data from the external device; and
a notification mail transmission unit configured such that if the state detection unit detects that the virus check device is not in the running state, the notification mail transmission unit generates a notification mail indicating that virus detection by the virus check device can not be performed and transmits the notification mail to the predetermined reception device.

10. The mail reception system according to claim 1,
wherein the data received by the data reception unit and to be transferred to the predetermined reception device comprises at least one of facsimile document data, an e-mail and image data.

11. A mail relay device communicatably connected to a virus check device having a function of virus detection, the mail relay device having a transferring function of transferring data transmitted from an external device to a predetermined reception device, the mail relay device comprising:
a data reception unit configured to receive data from the external device;
a data transmission unit configured to transmit the data received by the data reception unit to the virus check device before the data is transferred to the predetermined reception device; and
a check result reception unit configured to receive information concerning a result of virus detection from the virus check device.

12. The mail relay device according to claim 11,
wherein the mail relay device transfers the information concerning a result of virus detection to the predetermined reception device.

13. The mail relay device according to claim 11, wherein:
the check result reception unit receives the data from which a virus is eliminated by the virus check device; and
the mail relay device transfers the data from which the virus is eliminated to the predetermined reception device.

14. The mail relay device according to claim 13, wherein:
the check result reception unit receives a notification indicating that the virus is removed from the data, from the virus check device; and
the mail relay device transfers the notification to the predetermined reception device together with the data from which the virus is eliminated.

15. The mail relay device according to claim 11,
wherein the check result reception unit receives virus information as to whether a virus is contained in the data from the mail check device, as the information concerning a result of virus detection;
wherein the mail relay device further comprises:
a transfer function disabling unit configured to disable the transferring function in response to reception of the virus information indicating that a virus is contained in the data.

16. The mail relay device according to claim 11, further comprising:
a storage unit in which the data received by the data reception unit is stored; and
a data deletion unit configured to delete the data stored in the storage unit if the information concerning a result of virus detection indicates that a virus is contained in the data.

17. The mail relay device according to claim 11, further comprising:
a state detection unit configured to detect whether the virus check device is in a running state in response to reception of the data from the external device; and
an activation control unit configured to cause the virus check device to move to the running state if the state detection unit detects that the virus check device is not in the running state.

18. The mail relay device according to claim 11,
wherein the mail relay device further comprises:
a state detection unit configured to detect whether the virus check device is in a running state in response to reception of the data from the external device; and
a notification mail transmission unit configured such that if the state detection unit detects that the virus check device is not in the running state, the notification mail transmission unit generates a notification mail indicating that virus detection by the virus check device can not be performed and transmits the notification mail to the predetermined reception device.

19. The mail relay device according to claim 11, wherein the mail relay device is an internet facsimile device having a function of communicating with a device through the Internet.

20. A computer usable medium having computer readable instructions stored thereon, which, when executed by a computer which has a transferring function of transferring data transmitted from an external device to a predetermined reception device and is communicatably connected to a virus check device having a function of virus detection, are configured to:
receive data from the external device;
transmit the received data from the external device to the virus check device before the data is transferred to the predetermined reception device; and
receive information concerning a result of virus detection from the virus check device.
